(19) United States
(12) Patent Application Publication
(10) Pub. No.: US 2010/0073822 A1
(43) Pub. Date: Mar. 25, 2010

(54) MAGNETIC HEAD ASSEMBLY AND MAGNETIC DISK DEVICE

(75) Inventors: Masaharu Hida, Kawasaki (JP); Shigeyoshi Umemiya, Kawasaki (JP); Kazuaki Kurihara, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/510,649

(22) Filed: Jul. 28, 2009

(30) Foreign Application Priority Data
Sep. 24, 2008 (JP) 2008-243653

(51) Int. Cl. G11B 5/48

(52) U.S. Cl. 360/246.2; G9B/5.147

(57) ABSTRACT

A magnetic head assembly includes: a slider; an actuator disposed on an end face of the slider; and a magnetic head unit connected to the actuator. The actuator has a structure in which multiple electrodes are arranged in a piezoelectric body, and is driven in d33 mode. In other words, when a predetermined voltage is applied to the actuator, a portion between the electrodes in the piezoelectric body expands or contracts with respect to a voltage application direction. When the piezoelectric body of the actuator expands or contracts, the magnetic head unit is deformed, and the deformation causes a change of the distance between a magnetic head (recording element and reproducing element) and a magnetic recording medium.

### CROSS-REFERENCE TO RELATED APPLICATIONS

This application is based upon and claims and the benefit of priority of the prior Japanese Patent Application No. 2008-243653, filed Sep. 24, 2008, the entire contents of which are incorporated herein by reference.

### FIELD

The embodiment discussed herein relates to a magnetic head assembly and a magnetic disk device which are provided with an actuator for controlling a flying height of a magnetic head.

### BACKGROUND

An actuator is used in a lot of information equipment so as to control a small part for movement of a minute distance. For example, an actuator is used in information equipment including an optical system so as to correct a focus and control an inclination angle, and used in inkjet printers and magnetic disk devices so as to control movement of a printer head or a magnetic head. Recently, smaller and higher-performance information equipment has been developed more than ever, and there arises a desire for an actuator capable of controlling movement of a minute distance with high accuracy.

A magnetic disk device is a device in which a surface of a magnetic disk (recording medium) rotating at high speed is magnetized by a recording element and thereby information is magnetically recorded onto the magnetic disk. The recorded information is read by a reproducing element, converted into an electric signal, and then outputted. Hereinafter, the recording element and the reproducing element are collectively referred to as a magnetic head.

In response to a demand for an increase in capacity of the magnetic disk device, the recording capacity per magnetic disk is considerably increased. In order to increase the recording capacity without changing the size of the magnetic disk, it is essential to increase the number of tracks per unit length (track per inch: TPI), in other words, to reduce the width of each of the tracks and thereby arrange the tracks in high density.

The magnetic head is disposed on an end face of a substantially rectangular-parallelepiped-shaped member called a slider. In the present application, the slider provided with the magnetic head is called a magnetic head assembly. The magnetic head assembly is disposed on a tip end portion of a plate spring suspension, and slightly flies up from the magnetic disk due to an air flow generated by rotation of the magnetic disk. The distance between the magnetic head and the magnetic disk (hereinafter, also referred to as “flying height”) is determined by the strength of the air flow generated by the rotation of the magnetic disk and by a biasing force of the suspension applied to the magnetic head assembly.

Meanwhile, a change of the flying height occurring for some reason (for example, vibration, change in air pressure, or the like) causes a write error or a read error. In particular, in a magnetic disk device equipped with a recent high-recording-density magnetic disk, a slight change of the flying height causes a write error or a read error. To solve the problem, there has been proposed controlling of the flying height by use of a piezoelectric element or a heating element.

### SUMMARY

According to an aspect of the embodiment, a magnetic head assembly includes: a slider disposed so that a first face of the slider faces a magnetic recording medium; a magnetic head unit disposed on a side of a second face of the slider, the magnetic head unit including a recording element for writing information into the magnetic recording medium and a reproducing element for reading information from the magnetic recording medium; and an actuator disposed between the second face of the slider and the magnetic head unit. The actuator includes: a plurality of electrodes spaced from each other in a direction intersecting the first face; and a piezoelectric body between the electrodes, and when a voltage is applied to the plurality of electrodes, the actuator displaces the recording element and the reproducing element of the magnetic head unit in a direction of coming closer to or getting away from the magnetic recording medium.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a plan view depicting a magnetic disk device according to an embodiment;

FIG. 2 is a block diagram depicting an overview of a configuration of the magnetic disk device;

FIG. 3 is an exploded view depicting a tip end portion of a suspension and a magnetic head assembly;

FIG. 4 is a top view depicting the magnetic head assembly;

FIG. 5 is a cross-sectional view depicting the magnetic head assembly supported by a gimbal;

FIG. 6 is a schematic diagram depicting a magnetic head unit deformed by an actuator;

FIGS. 7A to 7D are cross-sectional views depicting a method of manufacturing the magnetic head assembly according to this embodiment in the order of steps;

FIGS. 8A and 8B are views each depicting dimensions of parts obtained by simulation calculations of the amount of change in flying height; and

FIG. 9 is a cross-sectional view depicting an example of a structure in which a gap is provided between the magnetic head unit and the gimbal.

### DESCRIPTION OF EMBODIMENT

Hereinafter, a preferred embodiment will be described with reference to the accompanying drawings.

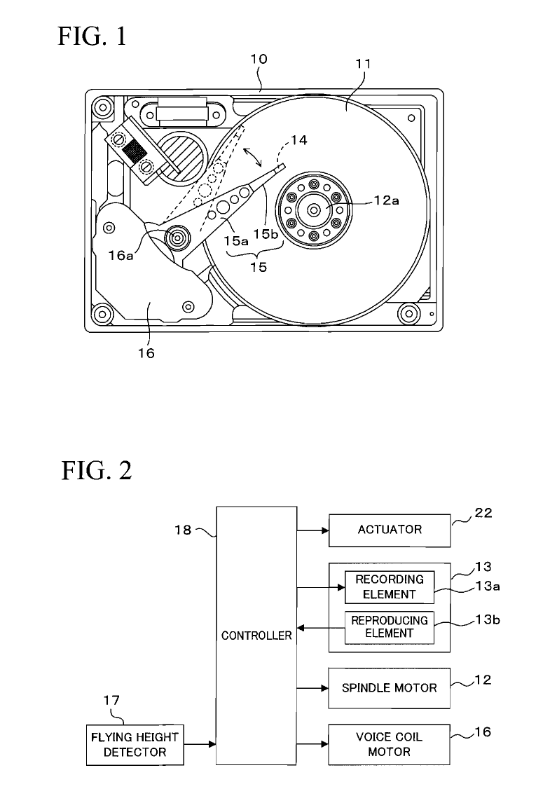

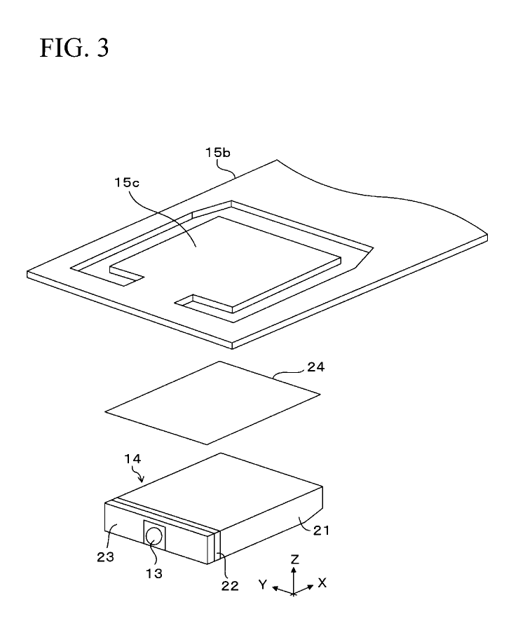

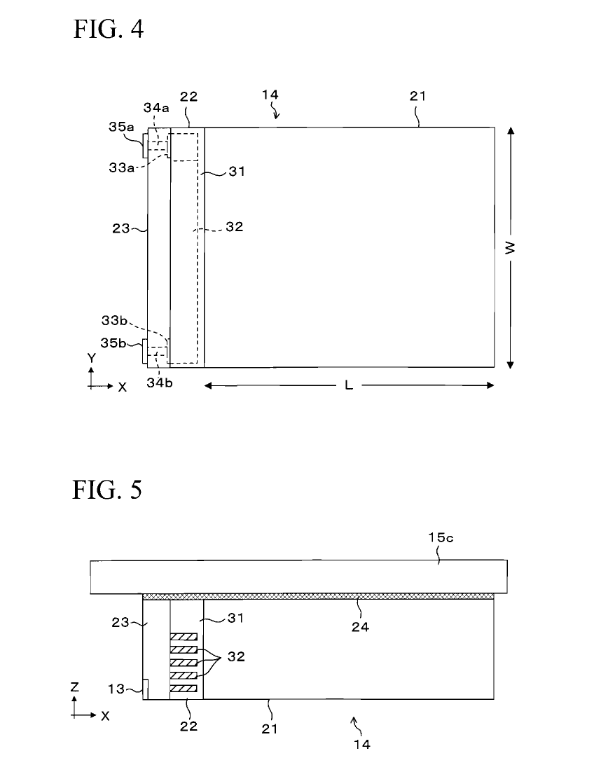

FIG. 1 is a plan view depicting a magnetic disk device according to the embodiment. FIG. 2 is a block diagram depicting an overview of a configuration of the magnetic disk device. FIG. 3 is an exploded view depicting a tip end portion of a suspension and a magnetic head assembly. FIG. 4 is a top view depicting the magnetic head assembly. Note that, in FIGS. 3 and 4, reference letter X denotes a direction in which tracks of a magnetic disk extends; Y denotes a track width direction; and Z denotes a direction perpendicular to a surface of the magnetic disk. These directions X, Y and Z are orthogonal to each other.

As depicted in FIGS. 1 and 2, the magnetic disk device according to this embodiment includes a housing 10 made of metal, a magnetic disk (magnetic recording medium) 11 having a disc shape and housed in the housing 10, a spindle motor 12, a magnetic head assembly 14, a suspension arm 15, a voice coil motor (suspension arm driver) 16, a flying height detector 17 and a controller (electronic circuit) 18.

The magnetic disk 11 is fixed to a rotating shaft 12a of the spindle motor 12, and is rotated at high speed by the spindle motor 12. The suspension arm 15 includes, on a base end side, a carriage arm 15a, and, on a tip end side, a suspension 15b of a plate spring shape. The suspension arm 15 is driven and controlled by the voice coil motor 16, and rotates about a rotating shaft 16a within a predetermined angle so as to move the magnetic head assembly 14 in a radial direction of the magnetic disk 11. The spindle motor 12 and the voice coil motor 16 are controlled by signals outputted from the controller 18.

As depicted in FIG. 3, a gimbal 15c surrounded by a C-shaped cut-out is provided in a tip end portion of the suspension 15b. The magnetic head assembly 14 is bonded to a surface, on a magnetic disk 11 side, of the gimbal 15c with an adhesive 24.

The magnetic head assembly 14 includes a slider 21, a flying height controlling actuator 22, which is disposed on an end face (a surface orthogonal to the direction X) of the slider 21, and a magnetic head unit 23 supported by the actuator 22. The actuator 22 is controlled by signals outputted from the controller 18.

The slider 21 is made of ceramic such as AlTiC and formed into a substantially rectangular-parallelepiped-shape. A length L (length in the direction X) of the slider 21 is, for example, 850 μm; a width W (length in the direction Y) is, for example, 700 μm; and a thickness t (length in the direction Z) is, for example, 240 μm (See FIG. 4). In this embodiment, out of faces of the slider 21, a face facing the magnetic disk 11 is referred to as a first face, and a face on which the actuator 22 and the magnetic head unit 23 are disposed is referred to as a second face.

As depicted in FIG. 3, the magnetic head unit 23 includes a magnetic head 13. The magnetic head 13 is formed by laminating a recording element 13a and a reproducing element 13b (See FIG. 2). As the recording element 13a, a magnetic monopole head, for example, is used, while as the reproducing element 13b, a magneto resistive (MR) element, a giant magneto resistive (GMR) element, or a tunnel magneto resistive (TMR) element, for example, is used. Through the recording element 13a and the reproducing element 13b, information is recorded onto and reproduced from the magnetic disk 11 by the controller 18.

FIG. 5 is a cross-sectional view depicting the magnetic head assembly 14 supported by the gimbal 15c.

As described above, the flying height controlling actuator 22 is sandwiched between the slider 21 and the magnetic head unit 23. The actuator 22 is formed by a piezoelectric body 31 and multiple embedded electrodes 32. The piezoelectric body 31 is made of a piezoelectric ceramic such as lead zirconate titanate (PZT) or lead nickel niobate (PNN)-PZT.

The embedded electrodes 32 are formed by filling grooves extending in the direction Y in the piezoelectric body 31, with a conductive material such as copper (Cu). In this embodiment, as depicted in FIG. 5, the multiple embedded electrodes 32 are arranged at a predetermined pitch, starting from a central portion to a lower portion of the piezoelectric body 31 in a height direction (direction Z) of the piezoelectric body 31, but are not provided in an upper portion of the piezoelectric body 31.

The embedded electrodes 32 which are odd-numbered from the top, for example, are connected to a common electrode 33a formed on end portions (an upper portion of FIG. 4), on one side, of the respective odd-numbered embedded electrodes 32 in the width direction (direction Y), whereas the even-numbered embedded electrodes 32 are connected to a common electrode 33b formed on end portions (a lower portion of FIG. 4), on the other side, of the respective even-numbered embedded electrodes 32 in the width direction. These common electrodes 33a, 33b are electrically connected to corresponding terminals 35a, 35b formed on a surface of the magnetic head unit 23, through wiring paths (such as wirings and vias) 34a, 34b formed in the magnetic head unit 23.

Hereinafter, description will be given of an operation of the actuator 22. When a voltage is not supplied to the actuator 22, the lower end of the magnetic head 13 is flush with the bottom face (first face) of the slider 21 as depicted in FIG. 5.

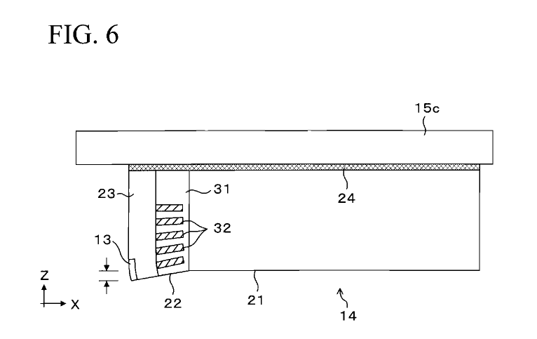

When a predetermined voltage is applied between the terminals 35a, 35b of the actuator 22, a portion between the embedded electrodes 32 in the piezoelectric body 31 expands in a voltage application direction (direction Z in FIG. 5). In this embodiment, however, no embedded electrodes 32 are arranged in the upper portion of the piezoelectric body 31, and a surface, on a slider 21 side, of the piezoelectric body 31 is held by the slider 21. For this reason, the length of the actuator 22 (length in the direction Z) on the slider 21 side does not change, and a portion from a central portion to a lower portion of a surface, on the magnetic head unit 23 side, of the actuator 22 expands downward and is thereby curved, as depicted in FIG. 6. In accordance with the deformation of the actuator 22, the lower end of the magnetic head 13 is lowered below the bottom face of the slider 21 to reduce the distance (flying height) between the magnetic head 13 and the magnetic disk 11. As will be described later, when voltages of 0 V to 30 V, for example, are applied to the actuator 22, the flying height is changed by approximately 0 nm to 13 nm.

Note that, in order to control the flying height so that the flying height is maintained at a certain height, detection of a change of the flying height is preferably performed. Since the suspension 15b is curved when the magnetic head assembly 14 flies, a change of the flying height can be detected by using, for example, a deformation sensor changing outputs according to the amount of curving of the suspension 15b. Alternatively, the change of the flying height may be detected based on change in output of the reproducing element 13b by reading, by the reproducing element 13b, predetermined data having been recorded in the magnetic disk 11 in advance. In such a manner, the flying height detector 17 detects the change of the flying height. Outputs from the flying height detector 17 are inputted into the controller 18, and the controller 18 controls voltages to be supplied to the actuator 22 according to the outputs of the flying height detector 17 so as to maintain the flying height at a constant height.

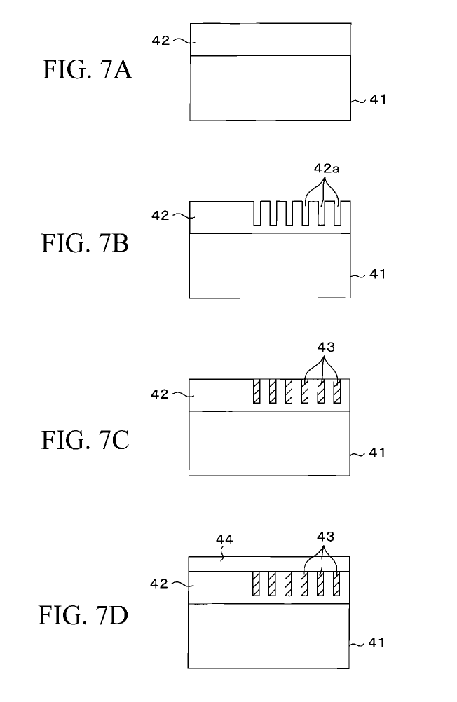

FIGS. 7A to 7D are cross-sectional views depicting a method of manufacturing a magnetic head assembly according to this embodiment in the order of manufacturing steps.

First, as depicted in FIG. 7A, an adhesion layer (unillustrated) is formed on an AlTiC substrate 41 to be formed into the slider 21, and then a PZT film 42 (corresponding to the piezoelectric body 31 in FIG. 5) is formed on the adhesion layer. The adhesion layer is formed by laminating, for example, a titanium (Ti) film having a thickness of 0.05 μm and a platinum (Pt) film having a thickness of 0.45 μm. The PZT film 42 has a thickness of 5 μm, for example. Instead of the PZT film 42, a PNN-PZT film or the like may be formed.

Next, as depicted in FIG. 7B, patterning is performed on the PZT film 42 by, for example, a dry etching process to form grooves 42a in a region where embedded electrodes are to be formed. In this case, in order that the odd-numbered embedded electrodes 32 and the even-numbered embedded electrodes 32 can be connected to corresponding one of the common electrodes 33a, 33b (see FIG. 4), odd-numbered grooves 42a and even-numbered grooves 42a are formed so as to be slightly shifted in a longitudinal direction thereof. The grooves 42a each have a depth of 3 μm, for example, and a width of 2 μm, for example, and are arranged at intervals of 8 μm, for example.

Subsequently, a plating seed layer (unillustrated) is formed on an entire upper surface of the AlTic substrate 41 by a spattering method, for example, and is plated with metal such as Cu by an electrolytic plating method, and then the grooves 42a are filled with a metal material. Thereafter, a metal film on the PZT film 42 is polished until the PZT film 42 is exposed, so that the surface thereof is planarized. Embedded electrodes 43 (corresponding to the embedded electrodes 32 in FIG. 5) formed by filling the grooves 42a with the metal material are formed in such a manner, as depicted in FIG. 7C.

Thereafter, the common electrodes 33a, 33b are formed on the PZT film 42. Specifically, the common electrode 33a is connected to the end portions, on the one side, of the odd-numbered embedded electrodes 32, while the common electrode 33b is connected to the end portions, on the other side, of the even-numbered embedded electrodes 32 (see FIG. 4).

Afterwards, a magnetic head unit 44 (corresponding to the magnetic head unit 23 in FIG. 5) having a recording element and a reproducing element is formed on the PZT film 42 and the embedded electrodes 32 by a well-known magnetic head formation process, as depicted in FIG. 7D.

When an MR element is used as the reproducing element, a soft adjacent layer (SAL) made of an NiFe alloy, a non-magnetic layer made of Ta or the like, and an MR layer made of NiFe or the like are laminated, and then patterning is performed on these layers by a photolithography method and an etching method, so that the reproducing element is formed. Meanwhile, when a magnetic monopole head is used as the recording element, a main pole and a return yoke are formed of a magnetic material, and then a coil is formed of a conductive material such as copper or aluminum. In this magnetic head formation process, the wiring paths 34a, 34b and the terminals 35a, 35b are formed as well as the recording element and the reproducing element, the wiring path 34a and the terminal 35a electrically connected to the common electrode 33a, the wiring path 34b and the terminal 35b electrically connected to the common electrode 33b.

After the PZT film 42, the embedded electrodes 43 and the magnetic head unit 44 are thus formed on the substrate 41, the substrate 41 is cut into separate magnetic head assemblies by using a dicing saw. The magnetic head assembly 14 depicted in FIG. 5 is completed by these manufacturing steps.

The magnetic head assembly 14 thus formed is attached to the suspension 15b (gimbal 15c) with the adhesive 24 (see FIG. 3). Subsequently, terminals of the magnetic head assembly 14 (electrodes of the actuator 22, recording element and reproducing element) are electrically connected to wirings provided to the suspension 15b, by wire bonding or the like.

Note that a poling process is preferably performed on the piezoelectric body 31 before the actuator 22 is used. In this embodiment, since the piezoelectric body 31 is used in d33 mode (mode in which the piezoelectric body 31 expands and contracts with respect to the voltage application direction), a predetermined voltage (for example, 10 V to 30 V) can be applied between the embedded electrodes 32. This means that the poling process can be performed after the magnetic head assembly 14 is completed and there is no need for steps of forming electrodes especially for the poling process and removing the electrodes after the poling process. Moreover, since the poling process can be performed after the magnetic head assembly 14 is formed, deterioration of poling characteristics can be avoided, the deterioration of the poling characteristics caused by heat applied to the PZT film 42 (piezoelectric body 31) in the magnetic head formation process.

In the magnetic head assembly 14 according to this embodiment, the flying height is controlled directly by the actuator 22 supporting the magnetic head unit 23, and therefore the flying height can be controlled at high speed and with high accuracy. Furthermore, the magnetic head assembly 14 according to this embodiment can be formed by using typical deposition steps and etching steps, and does not require the steps of forming electrodes for a poling process and removing the electrodes after the poling process. This facilitates the manufacturing of the magnetic head assembly 14.

Hereinbelow, description will be given of the result of examining the amount of displacement of the magnetic head of the magnetic head assembly according to this embodiment.

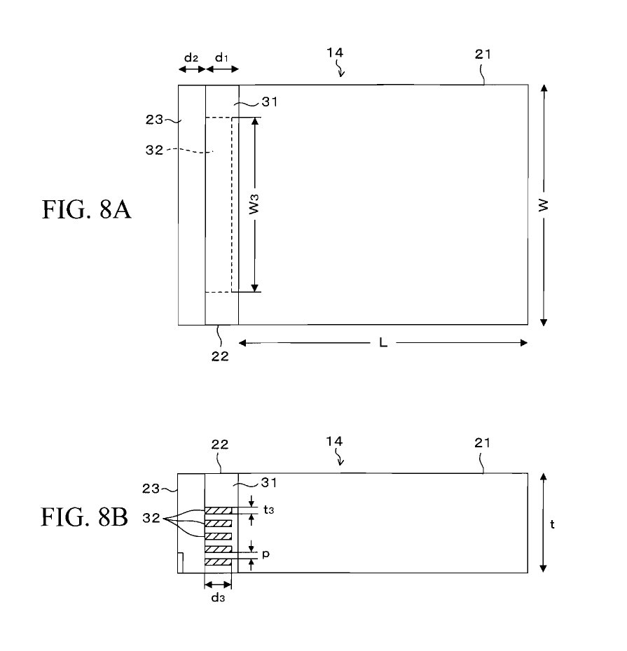

As depicted in FIG. 8A and 8B, the length L of the slider 21 is 850 μm, the width W thereof is 700 μm, and the thickness t thereof is 240 μm. Meanwhile, a thickness d1 of the piezoelectric body 31 is 5 μm, and a thickness d2 of the magnetic head unit 23 is 35 μm. A width W3 of each of the embedded electrodes 32 (activation portion) is 500 μm; a depth d3 thereof is 3 μm; a thickness t3 thereof is 2 μm; and an interval p between the embedded electrodes 32 is 8 μm. The number of the embedded electrodes 32 (the number of layers) is 16.

Simulation calculations are made to obtain the amount of movement of the magnetic head 13 in the case where voltages of 15 V to 30 V are applied to the piezoelectric body 31 through the embedded electrodes 32 in the magnetic head assembly 14. As the result, the amount of movement of the magnetic head 13 is 4 nm to 13 nm. It is confirmed that the sufficient amount of displacement for adjusting the flying height of the magnetic head 13 is obtained.

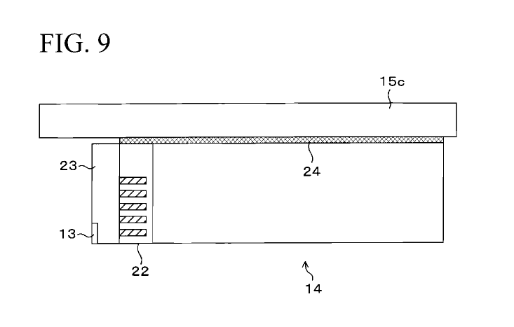

In the above embodiment, description has been given of the case where an upper surface of the magnetic head unit 23 is bonded to the gimbal 15c (suspension arm 15). Meanwhile, as depicted in FIG. 9, a gap may be provided between the magnetic head unit 23 and the gimbal 15c, thereby achieving a further increase in the amount of displacement of the magnetic head 13.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions has been described in detail, it should be understood that the various changes, substitutions, and alterations could be made hereto without departing from the spirit and scope of the invention.

What is claimed is:

1. A magnetic head assembly comprising:
a slider disposed so that a first face of the slider faces a magnetic recording medium;
a magnetic head unit disposed on a side of a second face of the slider, the magnetic head unit including a recording element for writing information into the magnetic recording medium and a reproducing element for reading information from the magnetic recording medium; and
an actuator disposed between the second face of the slider and the magnetic head unit, wherein
the actuator includes a plurality of electrodes spaced from each other in a direction intersecting the first face, and a piezoelectric body between the electrodes, and
when a voltage is applied to the plurality of electrodes, the actuator displaces the recording element and the reproducing element of the magnetic head unit in a direction of coming closer to or getting away from the magnetic recording medium.

2. The magnetic head assembly according to claim 1, wherein
the actuator includes a piezoelectric film formed on the second face of the slider, and a plurality of grooves formed in the piezoelectric film and extending in a direction parallel to the first face, and the electrodes are formed by filling the grooves with a conductive material.

3. The magnetic head assembly according to claim 1, wherein the electrodes of the actuator are formed only in a region from a central portion of the actuator in a direction intersecting the first face to an end portion, on a magnetic recording medium side, of the actuator in the direction intersecting the first face.

4. A magnetic disk device comprising:
a magnetic recording medium;
a magnetic head assembly;
a suspension arm supporting the magnetic head assembly; and
a suspension arm driver for driving the suspension arm to move the magnetic head assembly in a radial direction of the magnetic recording medium, wherein the magnetic head assembly includes:
a slider disposed so that a first face of the slider faces the magnetic recording medium;
a magnetic head unit disposed on a side of a second face of the slider, the magnetic head unit including a recording element for writing information into the magnetic recording medium and a reproducing element for reading information from the magnetic recording medium; and
an actuator disposed between the second face of the slider and the magnetic head unit,
the actuator includes a plurality of electrodes spaced from each other in a direction intersecting the first face, and a piezoelectric body between the electrodes, and
when a voltage is applied to the plurality of electrodes, the actuator displaces the recording element and the reproducing element of the magnetic head unit in a direction of coming closer to or getting away from the magnetic recording medium.

5. The magnetic disk device according to claim 4, further comprising a flying height detector for detecting a change of a distance from the recording element and the reproducing element to the magnetic recording medium.
